(19) United States
(12) Patent Application Publication
(10) Pub. No.: US 2025/0253571 A1
(43) Pub. Date: Aug. 7, 2025

(54) Terminal, Connector and Connector Assembly

(71) Applicant: Tyco Electronics (Shanghai) Co., Ltd., Shanghai (CN)

(72) Inventors: Weidong Zhang, Shanghai (CN); Lei Pan, Shanghai (CN)

(73) Assignee: Tyco Electronics (Shanghai) Co., Ltd., Shanghai (CN)

(21) Appl. No.: 19/047,886

(22) Filed: Feb. 7, 2025

(30) Foreign Application Priority Data
Feb. 7, 2024 (CN) 202410175968.1

(51) Int. Cl. H01R 13/187

(52) U.S. Cl. CPC H01R 13/187

(57) ABSTRACT

A terminal comprises a single terminal plate, a limit shell, and an elastic contact member. The terminal plate has top and bottom surfaces opposite to each other in a thickness direction. The limit shell includes a top plate located above the top surface of the terminal plate, and side plates connected to the top plate and fixed to the terminal plate by riveting. The elastic contact member is arranged on the top surface of the terminal plate and faces the top plate of the limit shell. The elastic contact member adapted to make electrical contact with a mating terminal inserted between the elastic contact member and the top plate of the limit shell and enables electrical connection between the terminal and the mating terminal.

### CROSS-REFERENCE TO RELATED APPLICATION

This application claims the benefit of Chinese Patent Application No. CN202410175968.1 filed on Feb. 7, 2024 in the State Intellectual Property Office of China, the whole disclosure of which is incorporated herein by reference.

### FIELD OF THE DISCLOSURE

The disclosure relates to a terminal, particularly to a terminal for a high voltage connector. In addition, the present invention also relates to a connector comprising the terminal and a connector assembly comprising the connector.

### BACKGROUND OF THE INVENTION

In the prior art, a terminal of a high-voltage connector typically includes a terminal body, a pair of elastic contact members, and a limit shell. The terminal body includes two terminal plates. There is a gap between the two terminal plates that allows for the insertion of a mating terminal. The pair of elastic contact members are set in the gap between two terminal plates and fixed to the inner surfaces of the two terminal plates, respectively. The elastic contact members clamp the mating terminal inserted between them to achieve electrical connection between the terminal and the mating terminal. The limit shell is fitted onto the two terminal plates of the terminal body, used to lock the terminal in the housing of the connector.

As the terminal body includes two terminal plates, the structure of the terminal is complex, the production cost is high, and the manufacturing difficulty is high. In addition, in the prior art, when vibration occurs, the gap between the two terminal plates will change, which can lead to poor electrical contact between the terminal and the mating terminal. Therefore, the terminal of the existing high-voltage connector is not suitable for environments prone to vibration.

### SUMMARY OF THE INVENTION

According to an embodiment of the present disclosure, a terminal comprises a single terminal plate, a limit shell, and an elastic contact member. The terminal plate has top and bottom surfaces opposite to each other in a thickness direction. The limit shell includes a top plate located above the top surface of the terminal plate, and side plates connected to the top plate and fixed to the terminal plate by riveting. The elastic contact member is arranged on the top surface of the terminal plate and faces the top plate of the limit shell. The elastic contact member adapted to make electrical contact with a mating terminal inserted between the elastic contact member and the top plate of the limit shell and enables electrical connection between the terminal and the mating terminal.

### DRAWINGS

The accompanying drawings incorporated therein and forming a part of the specification illustrate the present disclosure and, and together with the description, further serve to explain the principles of the disclosure and to enable those skilled in the relevant art to manufacture and use the embodiments described herein.

FIG. 1 shows an illustrative perspective view of a terminal according to the first embodiment of the present invention;

FIG. 2 shows an illustrative exploded view of a terminal according to the first embodiment of the present invention;

FIG. 3 shows a transverse sectional view of a terminal according to the first embodiment of the present invention;

FIG. 4 shows an illustrative exploded view of a terminal according to the second embodiment of the present invention;

FIG. 5 shows the assembly schematic of the terminal according to the second embodiment of the present invention, where the riveting piece has not yet been riveted into the riveting groove;

FIG. 6 shows the assembly schematic of the terminal according to the second embodiment of the present invention, in which the riveting piece has been riveted into the riveting groove;

FIG. 7 shows an illustrative exploded view of a terminal according to the second embodiment of the present invention;

FIG. 8 shows an illustrative perspective view of a terminal according to a third embodiment of the present invention as viewed from the top;

FIG. 9 shows an illustrative perspective view of a terminal according to a third embodiment of the present invention viewed from the bottom;

FIG. 10 shows an illustrative exploded view of a terminal according to a third embodiment of the present invention, viewed from the bottom;

FIG. 11 shows an illustrative perspective view of a terminal according to a fourth embodiment of the present invention;

FIG. 12 shows an illustrative exploded view of a terminal according to a fourth embodiment of the present invention;

FIG. 13 shows an illustrative perspective view of a terminal according to a fifth embodiment of the present invention;

FIG. 14 shows an illustrative perspective view of a terminal according to a sixth embodiment of the present invention;

FIG. 15 shows an illustrative perspective view of the terminal according to the seventh embodiment of the present invention when viewed from the top;

FIG. 16 shows an illustrative perspective view of the terminal according to the seventh embodiment of the present invention when viewed from the bottom;

FIG. 17 shows an illustrative perspective view of a terminal according to an eighth embodiment of the present invention;

FIG. 18 shows an illustrative exploded view of a terminal according to the eighth embodiment of the present invention;

FIG. 19 shows an illustrative perspective view of a terminal according to the ninth embodiment of the present invention;

FIG. 20 shows an illustrative perspective view of the terminal according to the tenth embodiment of the present invention when viewed from the top;

FIG. 21 shows an illustrative perspective view of the terminal according to the tenth embodiment of the present invention when viewed from the bottom;

FIG. 22 shows an illustrative perspective view of the terminal according to the eleventh embodiment of the present invention when viewed from the top;

FIG. 23 shows an illustrative perspective view of the terminal according to the eleventh embodiment of the present invention when viewed from the bottom;

FIG. 24 shows an illustrative perspective view of a terminal according to the twelfth embodiment of the present invention;

FIG. 25 shows an illustrative perspective view of a terminal according to the thirteenth embodiment of the present invention when viewed from the top;

FIG. 26 shows an illustrative perspective view of the terminal according to the thirteenth embodiment of the present invention when viewed from the bottom;

FIG. 27 shows an illustrative perspective view of a terminal according to the fourteenth embodiment of the present invention when viewed from the top; and

FIG. 28 shows an illustrative perspective view of the terminal according to the fourteenth embodiment of the present invention when viewed from the bottom.

### DETAILED DESCRIPTION

Hereinafter, embodiments will be described in detail with reference to the accompanying drawing. However, various alterations and modifications may be made to the embodiments. Here, the embodiments are not meant to be limited by the descriptions of the present disclosure. The embodiments should be understood to include all changes, equivalents, and replacements within the idea and the technical scope of the disclosure.

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to an embodiment of the present disclosure, a terminal comprises: a single terminal plate with top and bottom surfaces opposite to each other in its thickness direction; a limit shell including a top plate located above the top surface of the terminal plate, and side plates connected to the top plate and fixed to the terminal plate by riveting; and an elastic contact member which is installed on the top surface of the terminal plate and faces the top plate of the limit shell. The elastic contact member is used to make electrical contact with a mating terminal inserted between the elastic contact member and the top plate of the limit shell, in order to achieve electrical connection between the terminal and the mating terminal.

According to another embodiment of the present disclosure, a connector includes a housing and the above terminal inserted into the housing.

According to another embodiment of the disclosure, a connector assembly includes the above connector, and a mating connector which is mated with the connector. The mating connector comprise mating housing for mating with the housing of the connector; and a mating terminal adapted to be inserted between the elastic contact member of the connector and the top plate of the limit shell to make electrical contact with the elastic contact member of the connector.

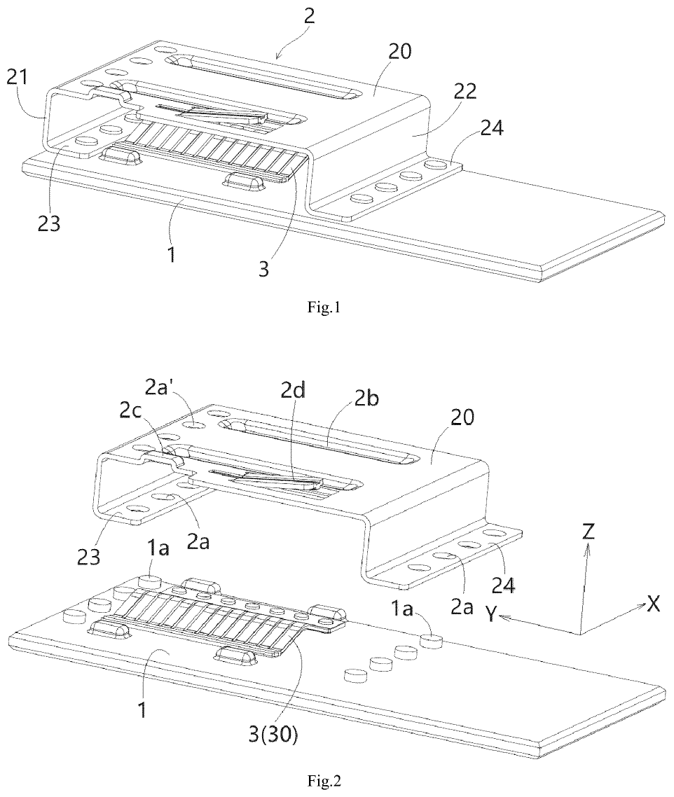

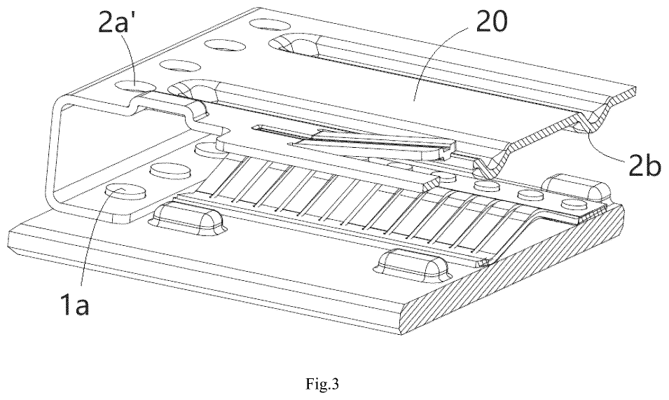

FIG. 1 shows an illustrative perspective view of a terminal according to the first embodiment of the present invention. FIG. 2 shows an illustrative exploded view of a terminal according to the first embodiment of the present invention. FIG. 3 shows a transverse sectional view of the terminal according to the first embodiment of the present invention.

As shown in FIGS. 1-3, in an exemplary embodiment of the present invention, a terminal is disclosed. The terminal includes a single terminal plate 1, a limit shell 2, and an elastic contact member 3. The terminal plate 1 has top and bottom surfaces that are opposite in its thickness direction Z. The limit shell 2 is riveted to the terminal plate 1 and includes a top plate 20 located above the top surface of the terminal plate 1. The elastic contact member 3 is installed on the top surface of the terminal plate 1 and faces the top plate 20 of the limit shell 2. The elastic contact member 3 is used to make electrical contact with a mating terminal inserted between the elastic contact member 3 and the top plate 20 of the limit shell 2, in order to achieve electrical connection between the terminal and the mating terminal.

In the illustrated embodiment, the terminal plate 1 has a front end and a rear end that are opposite in its longitudinal direction Y, and the limit shell 2 and the elastic contact member 3 are installed on the front portion of the terminal plate 1. The limit shell 2 has left and right openings opposite to each other in the transverse direction X of the terminal plate 1, to allow the mating terminal to be inserted between the elastic contact member 3 and the top plate 20 of the limit shell 2 along the transverse direction X of the terminal plate 1.

The limit shell 2 further comprises a front side plate 21, a rear side plate 22, a front riveting plate 23, and a rear riveting plate 24. The front side plate 21 is connected to the front side of the top plate 20. The front riveting plate 23 is connected to the lower side of the front side plate 21 and bent vertically towards the rear. The rear side plate 22 is connected to the rear side of the top plate 20. The rear riveting plate 24 is connected to the lower side of the rear side plate 22 and bent vertically towards the rear. The front riveting plate 23 is riveted to the top surface of the terminal plate 1, and the rear riveting plate 24 is riveted to the top surface of the terminal plate 1 to fix the limit shell 2 to the terminal plate 1.

The front riveting plate 23 and the rear riveting plate 24 are in a strip shape and extend along the transverse direction X of the terminal plate 1. Multiple riveting holes 2a are formed in the front riveting plate 23 and the rear riveting plate 24, and multiple riveting posts 1a are formed on the terminal plate 1. The multiple riveting posts 1a are respectively riveted into the multiple riveting holes 2a to rivet the front riveting plate 23 and the rear riveting plate 24 to the terminal plate 1. The front riveting plate 23 is riveted to the top surface of the terminal plate 1, and the riveting post 1a protrudes from the top surface of the terminal plate 1. Multiple operating holes 2a′ are formed in the top plate 20 of the limit shell 2, corresponding to the multiple riveting holes 2a in the front riveting plate 23, to allow the riveting stamping heads on the riveting tool to pass through the top plate 20.

At least one inwardly protruding rib 2b is formed on the top plate 20 of the limit shell 2. The rib 2b extends along the longitudinal direction Y of the terminal plate 1 and is used to apply a predetermined pressure on the inserted mating terminal to ensure reliable electrical contact between the mating terminal and the elastic contact member 3. The cross-section of the rib 2b can be semi-circular, U-shaped, or V-shaped.

Still referring to FIGS. 1-3, a foolproof or failsafe protrusion 2c is formed on the top plate 20 of the limit shell 2, which is used to cooperate with a guide groove (not shown) in the housing (not shown) of the connector to guide the terminal to be inserted into the housing of the connector in the correct orientation.

One or more elastic locking buckles 2d are formed on the top plate 20 of the limit shell 2, and the elastic locking buckles 2d are used to engage with the housing of the connector to lock the terminal in the housing of the connector.

The elastic contact member 3 includes multiple elastic arms 30 extending along the transverse direction X of the terminal plate 1, and the multiple elastic arms 30 are arranged in a row along the longitudinal direction Y of the terminal plate 1. The multiple elastic arms 30 of the elastic contact member 3 are used to simultaneously make electrical contact with the mating terminal inserted along the transverse direction X of the terminal plate 1.

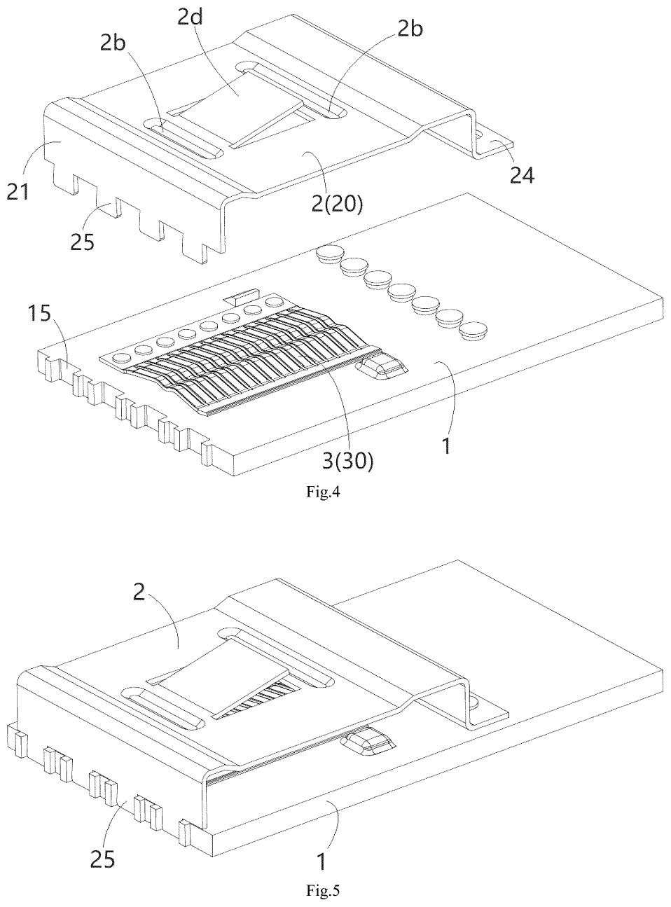

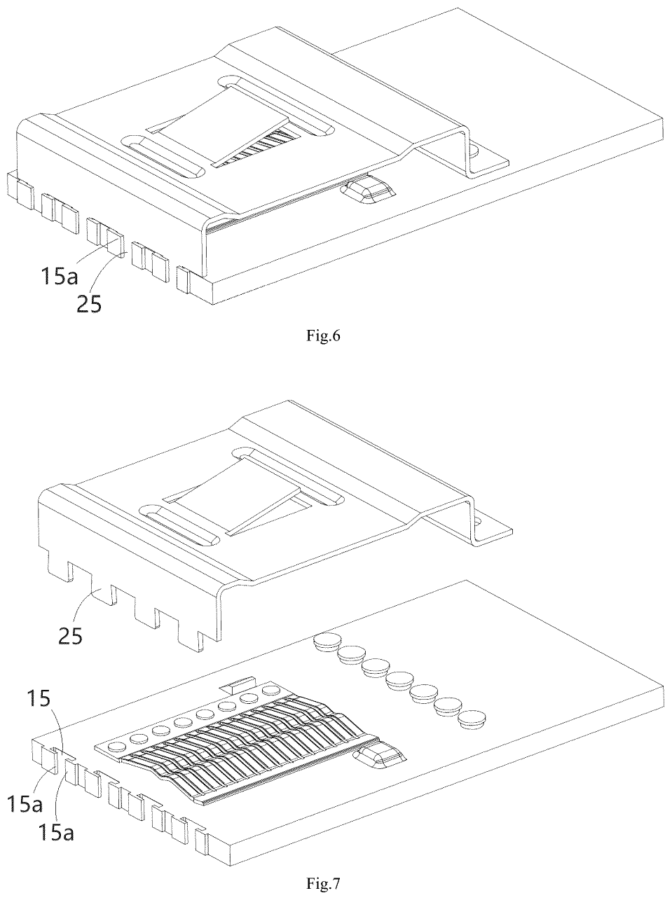

FIG. 4 shows an illustrative exploded view of a terminal according to the second embodiment of the present invention. FIG. 5 shows the assembly schematic of the terminal according to the second embodiment of the present invention, where the riveting piece has not yet been riveted into the riveting groove. FIG. 6 shows the assembly schematic of the terminal according to the second embodiment of the present invention, in which the riveting piece has been riveted into the riveting groove. FIG. 7 shows an illustrative exploded view of a terminal according to the second embodiment of the present invention.

A difference between the second embodiment shown in FIGS. 4-7 and the first embodiment shown in FIGS. 1-3 is the riveting method between the front side plate 21 and the terminal plate 1. Specifically, as shown in FIGS. 4-7, in the illustrated embodiment, the limit shell 2 includes multiple riveting pieces 25. Multiple riveting pieces 25 are connected to the lower side of the front side plate 21 and extend downwards. Multiple riveting grooves 15 corresponding to multiple riveting pieces 25 are formed on the front end surface of terminal plate 1, and the multiple riveting grooves 15 are arranged in a row along the transverse X direction of terminal plate 1. Multiple riveting pieces 25 are respectively riveted into multiple riveting grooves 15, and the rear riveting plate 24 is riveted onto the top surface of the terminal plate 1 to fix the limit shell 2 to the terminal plate 1.

In the illustrated embodiment, the side walls 15a on both sides of the riveting groove 15 are rolled towards the inner side of the riveting groove 15 and pressed against the outer surfaces of both sides of the riveting piece 25 during riveting, in order to rivet the riveting piece 25 in the riveting groove 15.

At least one inwardly protruding rib 2b is formed on the top plate 20 of the limit shell 2. The rib 2b extends along the transverse direction X of the terminal plate 1 and is used to apply a predetermined pressure on the inserted mating terminal to ensure reliable electrical contact between the mating terminal and the elastic contact member 3.

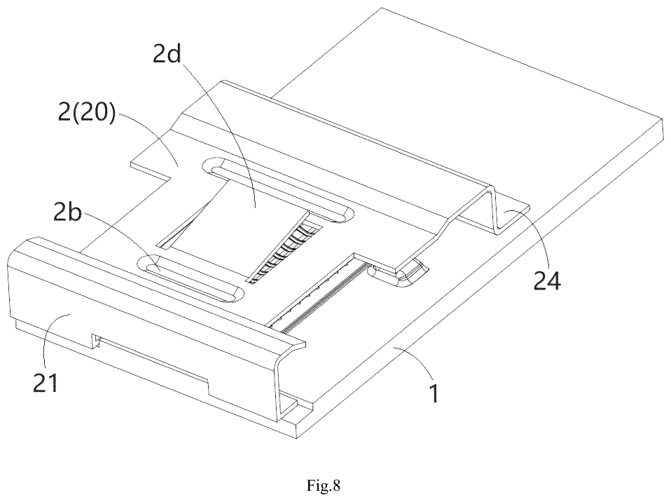

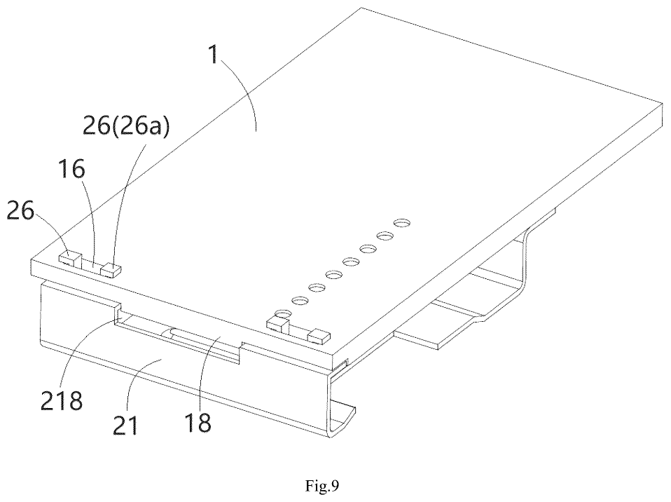

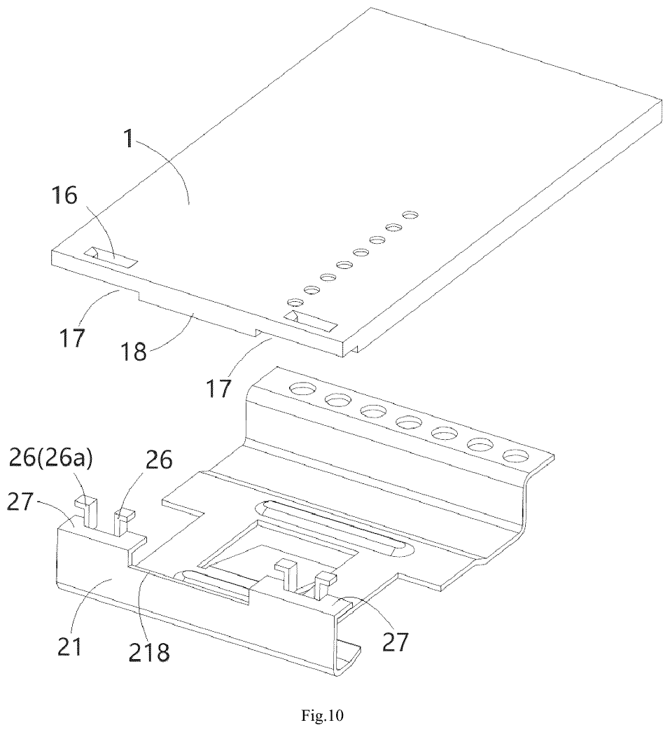

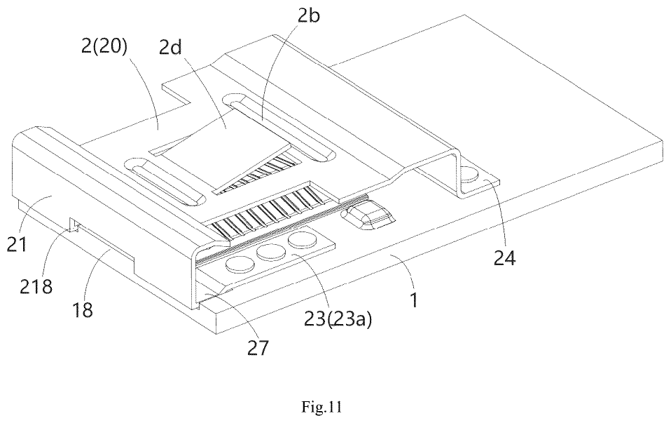

FIG. 8 shows an illustrative perspective view of a terminal according to a third embodiment of the present invention as viewed from the top. FIG. 9 shows an illustrative perspective view of a terminal according to a third embodiment of the present invention viewed from the bottom. FIG. 10 shows an illustrative exploded view of the terminal according to the third embodiment of the present invention when viewed from the bottom. A difference between the third embodiment shown in FIGS. 8-10 and the first embodiment shown in FIGS. 1-3 is the riveting method between the front side plate 21 and the terminal plate 1.

As shown in FIGS. 8-10, in the illustrated embodiment, the limit shell 2 includes at least one pair of rivet legs 26, which are connected to the lower side of the front side plate 21 and extend downward. At least one slot 16 corresponding to at least one pair of rivet legs 26 is formed on the terminal plate 1, and each pair of rivet legs 26 passes through the corresponding slot 16 and is riveted to the bottom surface of the terminal plate 1. The rear riveting plate 24 is riveted to the top surface of the terminal plate 1 to fix the limit shell 2 to the terminal plate 1.

In the illustrated embodiment, the end portions 26a of each pair of rivet legs 26 are bent in opposite directions away from each other by stamping during riveting and pressed against the bottom surface of the terminal plate 1 to rivet the rivet legs 26 to the bottom surface of the terminal plate 1.

The limit shell 2 further includes a pair of positioning parts 27, which are connected to the lower side of the front side plate 21 and bent vertically towards the rear. The rivet leg 26 is connected to positioning part 27. A pair of positioning slots 17 are formed on the top surface of terminal plate 1, which are located on the left and right sides of terminal plate 1, respectively. A pair of positioning parts 27 are positioned in the pair of positioning slots 17.

A positioning groove 218 is formed on the lower side of the front side plate 21 of the limit shell 2, and the positioning groove 218 is located between the pair of positioning parts 27. Terminal plate 1 has positioning protrusions 18 located between the pair of positioning slots 17, which are positioned in positioning grooves 218.

At least one inwardly protruding rib 2b is formed on the top plate 20 of the limit shell 2. The rib 2b extends along the transverse direction X of the terminal plate 1 and is used to apply a predetermined pressure on the inserted mating terminal to ensure reliable electrical contact between the mating terminal and the elastic contact member 3.

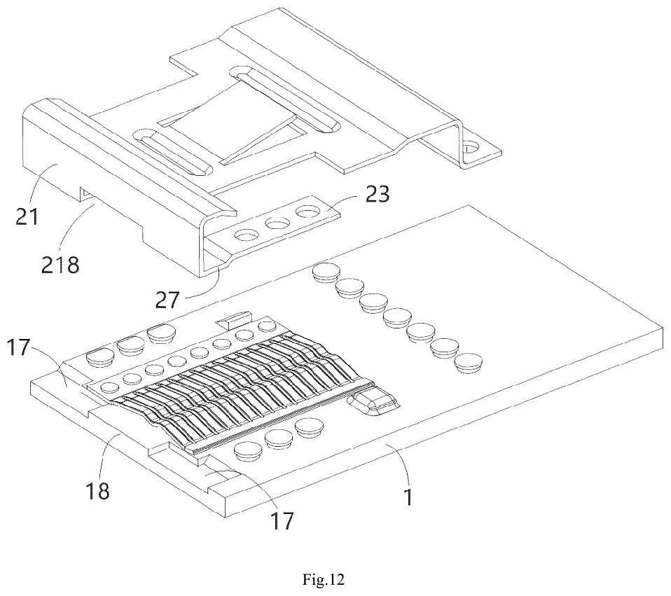

FIG. 11 shows an illustrative perspective view of a terminal according to a fourth embodiment of the present invention. FIG. 12 shows an illustrative exploded view of a terminal according to the fourth embodiment of the present invention. A difference between the fourth embodiment shown in FIG. 11 and the first embodiment shown in FIGS. 1-3 is the structure of the front riveting plate 23.

As shown in FIG. 11, in the illustrated embodiment, the front riveting plate 23 includes a pair of strip-shaped portions 23a that are riveted to the terminal plate 1. The pair of strip-shaped portions 23a are located on the left and right sides of the terminal plate 1 and extend along the longitudinal direction Y of the terminal plate 1.

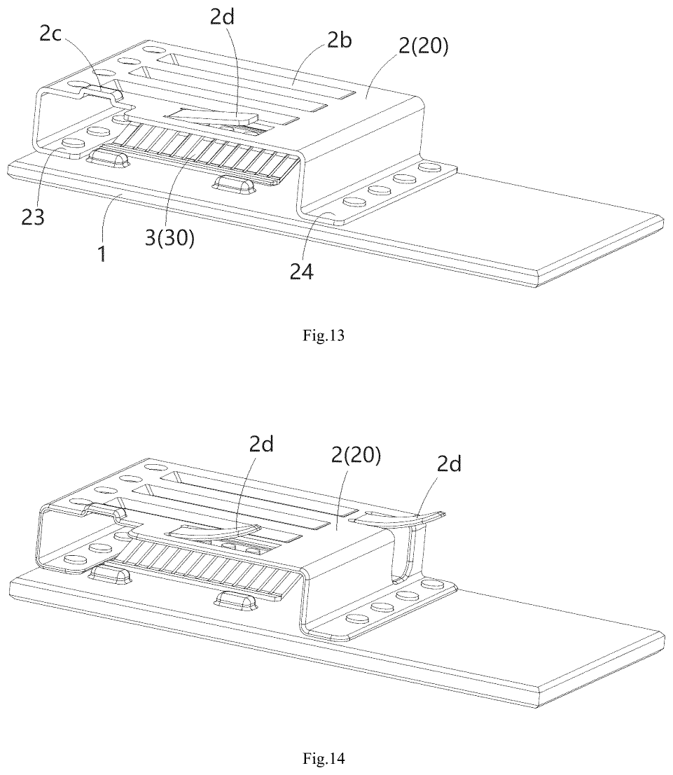

FIG. 13 shows an illustrative perspective view of a terminal according to the fifth embodiment of the present invention. A difference between the fifth embodiment shown in FIG. 13 and the first embodiment shown in FIGS. 1-3 is the number of ribs 2b on the top plate 20 of the limit shell 2. In the first embodiment, two ribs 2b are formed on the top plate 20 of the limit shell 2. In the fifth embodiment, three ribs 2b are formed on the top plate 20 of the limit shell 2.

FIG. 14 shows an illustrative perspective view of a terminal according to the sixth embodiment of the present invention. The main difference between the sixth embodiment shown in FIG. 14 and the first embodiment shown in FIGS. 1-3 is the number and position of elastic locking buckles 2d on the top plate 20 of the limit shell 2. In the first embodiment, only one elastic locking buckle 2d is formed on the top plate 20 of the limit shell 2. In the sixth embodiment shown in FIG. 14, two elastic locking buckles 2d are formed on the top plate 20 of the limit shell 2, and the two elastic locking buckles 2d are spaced apart in the longitudinal direction Y of the terminal plate 1.

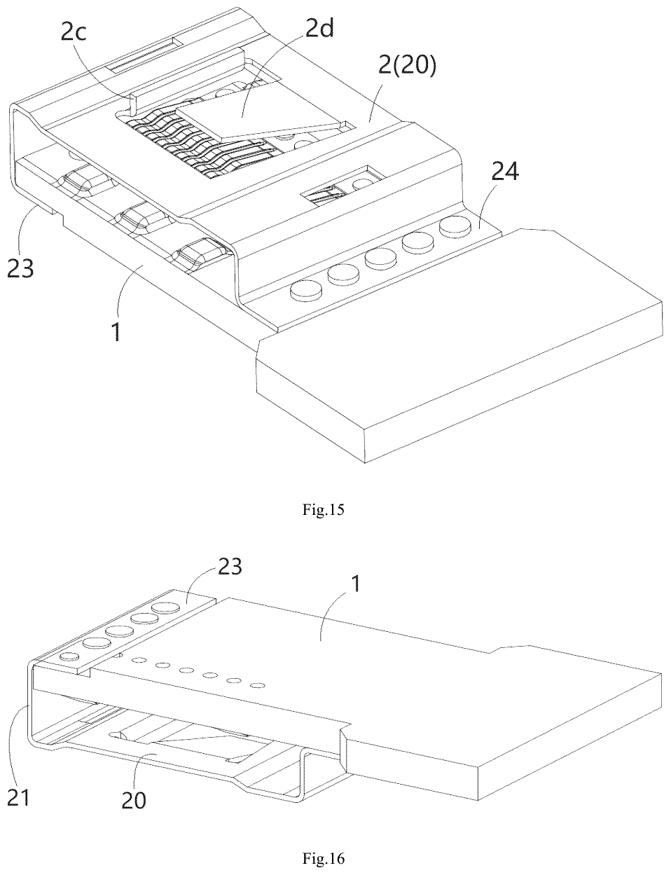

FIG. 15 shows an illustrative perspective view of the terminal according to the seventh embodiment of the present invention when viewed from the top. FIG. 16 shows an illustrative perspective view of the terminal according to the seventh embodiment of the present invention when viewed from the bottom. A difference between the seventh embodiment shown in FIGS. 15 and 16 and the first embodiment shown in FIGS. 1-3 is the structure of the foolproof protrusion 2c and the elastic locking buckle 2d on the top plate 20 of the limit shell 2.

In the first embodiment shown in FIGS. 1-3, the foolproof protrusion 2c is in the shape of a convex hull, and the elastic locking buckle 2d extends obliquely along the longitudinal direction Y of the terminal plate 1. In the seventh embodiment shown in FIGS. 15 and 16, the foolproof protrusion 2c is rib shaped and extends along the transverse direction X of the terminal plate 1, and the elastic locking buckle 2d extends obliquely along the transverse direction X of the terminal plate 1, so that the terminal can be inserted into the housing of the connector along the transverse direction X of the terminal plate 1.

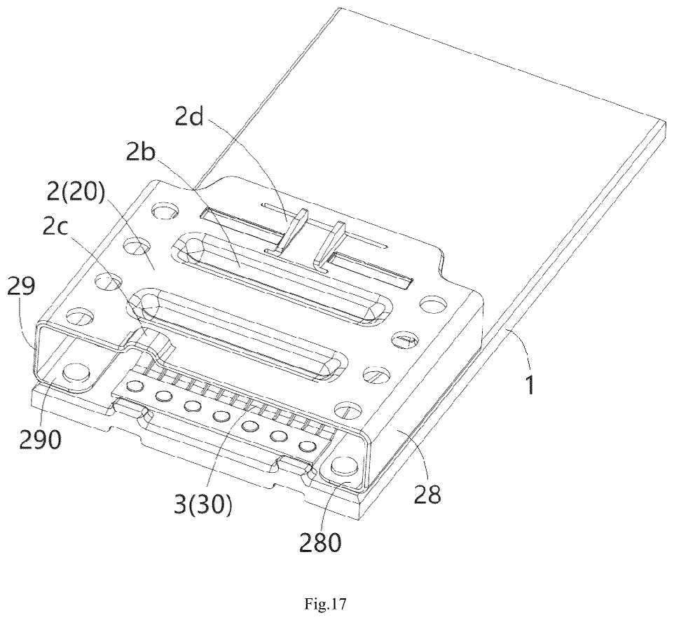

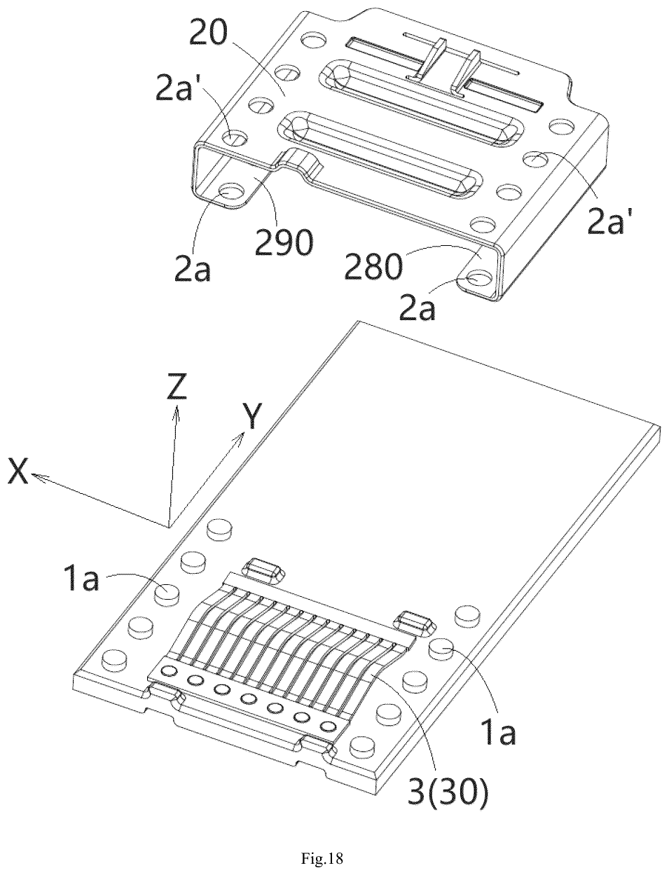

FIG. 17 shows an illustrative perspective view of a terminal according to an eighth embodiment of the present invention. FIG. 18 shows an illustrative exploded view of a terminal according to the eighth embodiment of the present invention.

As shown in FIGS. 17 and 18, in the illustrated embodiment, a terminal is disclosed. The terminal includes: a single terminal plate 1, a limit shell 2, and an elastic contact member 3. Terminal plate 1 has top and bottom surfaces that are opposite in its thickness direction Z. The limit shell 2 is riveted to the terminal plate 1 and includes a top plate 20 located above the top surface of the terminal plate 1. The elastic contact member 3 is installed on the top surface of the terminal plate 1 and faces the top plate 20 of the limit shell 2. The elastic contact member 3 is used to make electrical contact with the mating terminal inserted between the elastic contact member 3 and the top plate 20 of the limit shell 2, in order to achieve electrical connection between the terminal and the mating terminal.

In the illustrated embodiment, the terminal plate 1 has a front end and a rear end that are opposite in its longitudinal direction Y, and the limit shell 2 and the elastic contact member 3 are installed on the front portion of the terminal plate 1. The limit shell 2 has front and rear openings opposite to each other in the longitudinal direction Y of the terminal plate 1, to allow mating terminals to be inserted from the front opening of the limit shell 2 along the longitudinal direction Y of the terminal plate 1.

The limit shell 2 further comprises a left side plate 28, a left riveting plate 280, a right side plate 29, and a right riveting plate 290. The left side plate 28 is connected to the left side of the top plate 20. The left riveting plate 280 is connected to the lower side of the left side plate 28 and bent vertically to the right. The right side plate 29 is connected to the right side of the top plate 20. The right riveting plate 290 is connected to the lower side of the right side plate 29 and bent vertically to the left. The left riveting plate 280 and the right riveting plate 290 are riveted to the top surface of the terminal plate 1 to fix the limit shell 2 to the terminal plate 1.

In the illustrated embodiment, the left riveting plate 280 and the right riveting plate 290 are strip-shaped and extend along the longitudinal direction Y of the terminal plate 1.

Multiple riveting holes 2a are formed in the left riveting plate 280 and the right riveting plate 290, and multiple riveting posts 1a are formed on the terminal plate 1. The multiple riveting posts 1a are respectively riveted into the multiple riveting holes 2a to rivet the left riveting plate 280 and the right riveting plate 290 to the terminal plate 1. The left riveting plate 280 and the right riveting plate 290 are riveted to the top surface of the terminal plate 1, and the riveting post 1a protrudes from the top surface of the terminal plate 1. Multiple operating holes 2a′ are formed in the top plate 20 of the limit shell 2, corresponding to the riveting holes 2a in the left riveting plate 280 and the right riveting plate 290, respectively, to allow the riveting stamping heads on the riveting tool to pass through the top plate 20.

At least one inwardly protruding rib 2b is formed on the top plate 20 of the limit shell 2. The rib 2b extends along the longitudinal direction Y or transverse direction X of the terminal plate 1 and is used to apply a predetermined pressure on the inserted mating terminal to ensure reliable electrical contact between the mating terminal and the elastic contact member 3. In the illustrated embodiment, the cross-section of the rib 2b is semi-circular, U-shaped, or V-shaped.

As shown in FIGS. 17 to 18, in the illustrated embodiment, a foolproof protrusion 2c is formed on the top plate 20 of the limit housing 2, which is used to cooperate with the guide groove in the housing of the connector to guide the terminal to be inserted into the housing of the connector in the correct orientation. One or more elastic locking buckles 2d are formed on the top plate 20 of the limit shell 2, and the elastic locking buckles 2d are used to engage with the housing of the connector to lock the terminal in the housing of the connector. In the illustrated embodiment, the elastic locking buckle 2d is in an L-shaped cantilever shape. An elastic locking buckle 2d is formed on the left side plate 28 and/or the right side plate 29 of the limit housing 2. The elastic locking buckle 2d is used to engage with the housing of the connector to lock the terminal in the housing of the connector.

The elastic contact member 3 includes multiple elastic arms 30 extending along the longitudinal direction Y of the terminal plate 1, and the multiple elastic arms 30 are arranged in a row along the transverse direction X of the terminal plate 1. The multiple elastic arms 30 of the elastic contact member 3 are used to simultaneously make electrical contact with the mating terminal inserted along the longitudinal direction Y of the terminal plate 1.

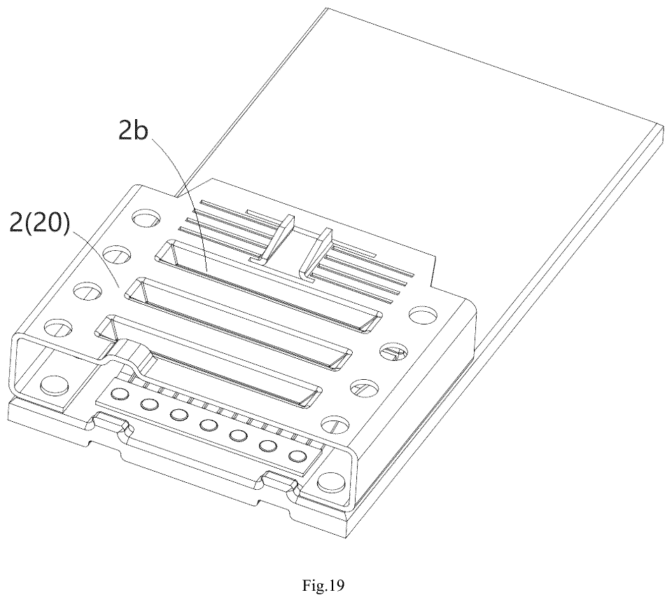

FIG. 19 shows an illustrative perspective view of a terminal according to the ninth embodiment of the present invention. A difference between the ninth embodiment shown in FIG. 19 and the eighth embodiment shown in FIGS. 17 and 18 is the number of ribs 2b on the top plate 20 of the limit shell 2.

In the eighth embodiment shown in FIGS. 17 and 18, the number of ribs 2b on the top plate 20 of the limit shell 2 is two. In the ninth embodiment shown in FIG. 19, the number of ribs 2b on the top plate 20 of the limit shell 2 is three.

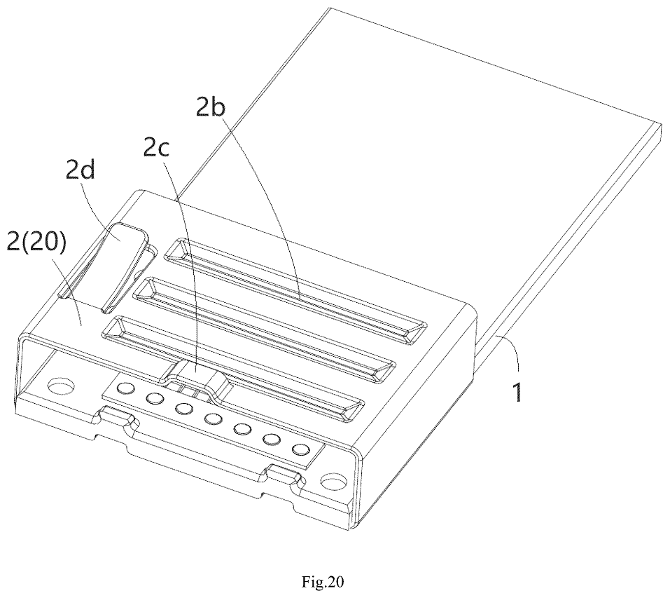

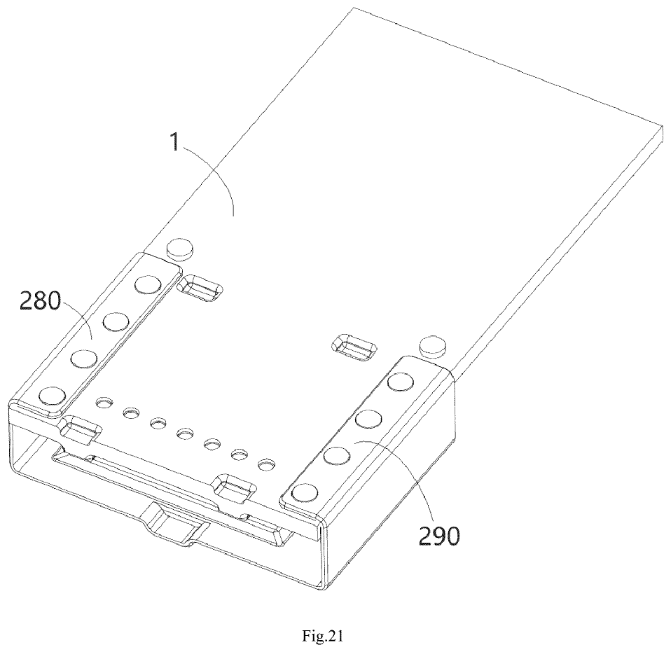

FIG. 20 shows an illustrative perspective view of the terminal according to the tenth embodiment of the present invention when viewed from the top. FIG. 21 shows an illustrative perspective view of the terminal according to the tenth embodiment of the present invention when viewed from the bottom. A difference between the tenth embodiment shown in FIGS. 20 and 21 and the eighth embodiment shown in FIGS. 17 and 18 is the different riveting positions of the left riveting plate 280 and the right riveting plate 290.

In the eighth embodiment shown in FIGS. 17 and 18, the left riveting plate 280 and the right riveting plate 290 are riveted to the top surface of the terminal plate 1. In the tenth embodiment shown in FIGS. 20 and 21, the left riveting plate 280 and the right riveting plate 290 are riveted to the bottom surface of the terminal plate 1. In addition, in the tenth embodiment shown in FIGS. 20 and 21, the elastic locking buckle 2d on the top plate 20 of the limit shell 2 is located on the left side and has an arc-shaped spring like shape.

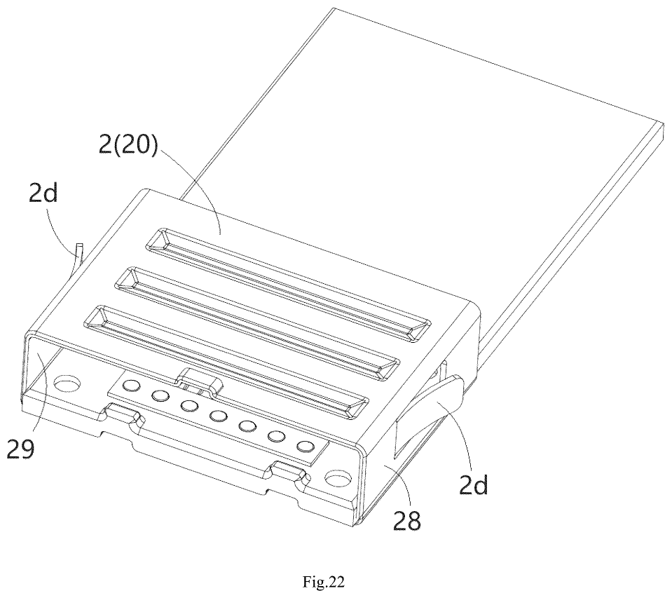

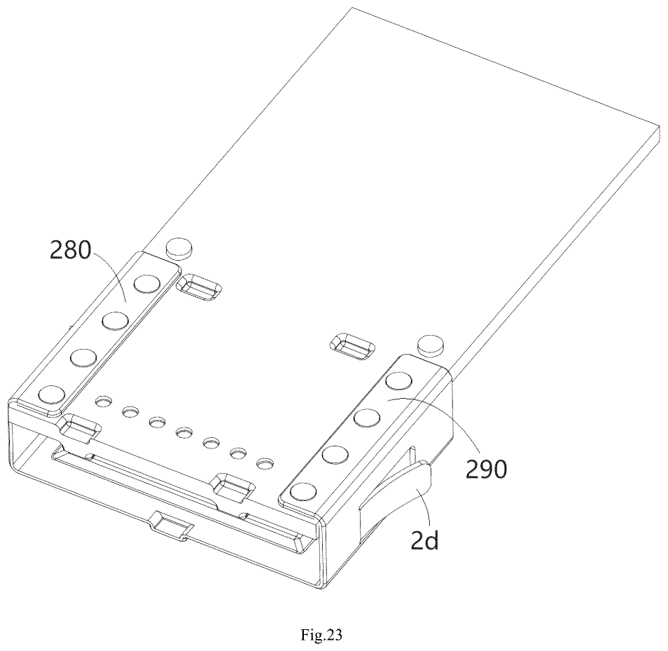

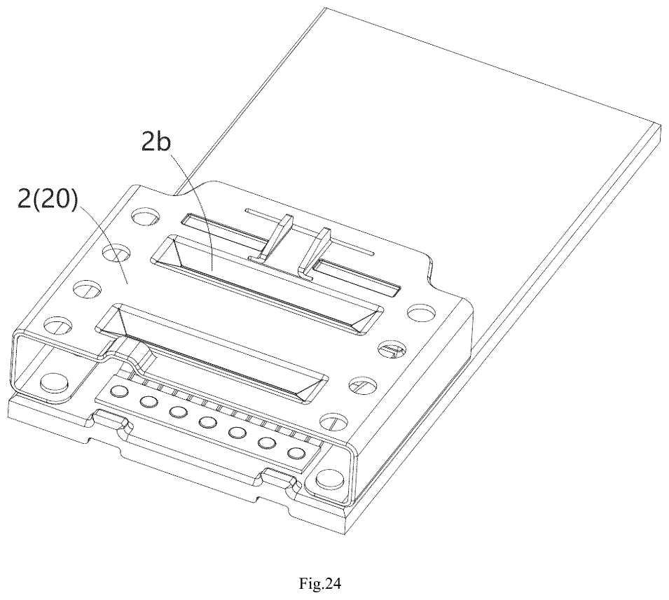

FIG. 22 shows an illustrative perspective view of the terminal according to the eleventh embodiment of the present invention when viewed from the top. FIG. 23 shows an illustrative perspective view of the terminal according to the eleventh embodiment of the present invention when viewed from the bottom. A difference between the eleventh embodiment shown in FIGS. 22 and 23 and the eighth embodiment shown in FIGS. 17 and 18 is the different riveting positions of the left riveting plate 280 and the right riveting plate 290.

In the eighth embodiment shown in FIGS. 17 and 18, the left riveting plate 280 and the right riveting plate 290 are riveted to the top surface of the terminal plate 1. In the eleventh embodiment shown in FIGS. 22 and 23, the left riveting plate 280 and the right riveting plate 290 are riveted to the bottom surface of the terminal plate 1. In addition, in the eleventh embodiment shown in FIGS. 22 and 23, there is no elastic locking buckle 2d provided on the top plate 20 of the limit shell 2. The elastic locking buckles 2d are formed on the left side plate 28 and the right side plate 29 of the limit shell 2 and has an arc-shaped spring like shape.

FIG. 24 shows an illustrative perspective view of a terminal according to the twelfth embodiment of the present invention. A difference between the twelfth embodiment shown in FIG. 24 and the eighth embodiment shown in FIGS. 17 and 18 is that the cross-section of the rib 2b on the top plate 20 of the limit shell 2 is different.

In the eighth embodiment shown in FIGS. 17 and 18, the cross-section of the rib 2b is U-shaped. In the twelfth embodiment shown in FIG. 24, the cross-section of the rib 2b is V-shaped.

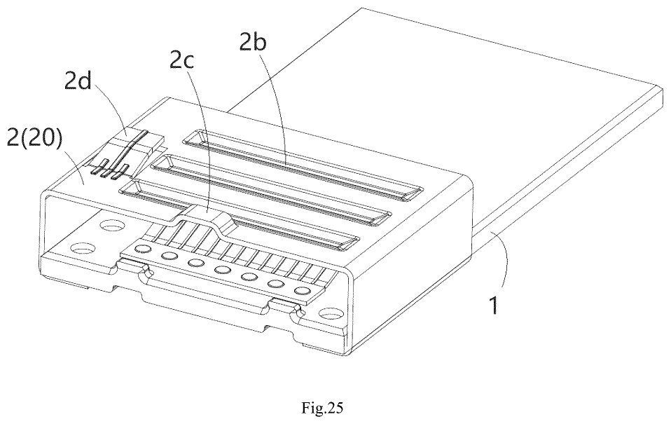

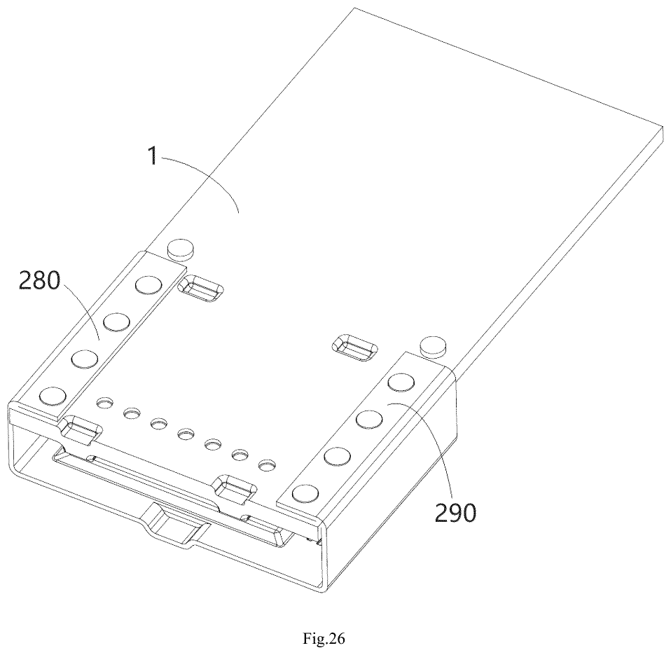

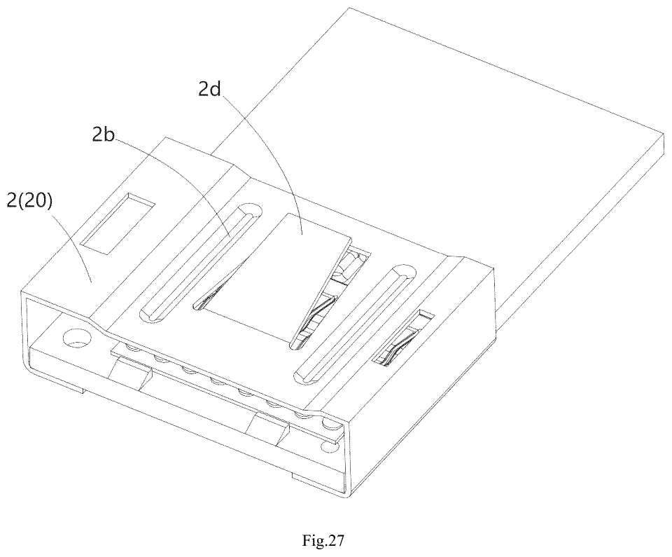

FIG. 25 shows an illustrative perspective view of a terminal according to the thirteenth embodiment of the present invention when viewed from the top. FIG. 26 shows an illustrative perspective view of the terminal according to the thirteenth embodiment of the present invention when viewed from the bottom. A difference between the thirteenth embodiment shown in FIGS. 25 and 26 and the eighth embodiment shown in FIGS. 17 and 18 is the different riveting positions of the left riveting plate 280 and the right riveting plate 290.

In the eighth embodiment shown in FIGS. 17 and 18, the left riveting plate 280 and the right riveting plate 290 are riveted to the top surface of the terminal plate 1. In the thirteenth embodiment shown in FIGS. 25 and 26, the left riveting plate 280 and the right riveting plate 290 are riveted to the bottom surface of the terminal plate 1. In addition, in the thirteenth embodiment shown in FIGS. 25 and 26, the elastic locking buckle 2d is located on the left side of the top plate 20 and has an arc-shaped spring like shape.

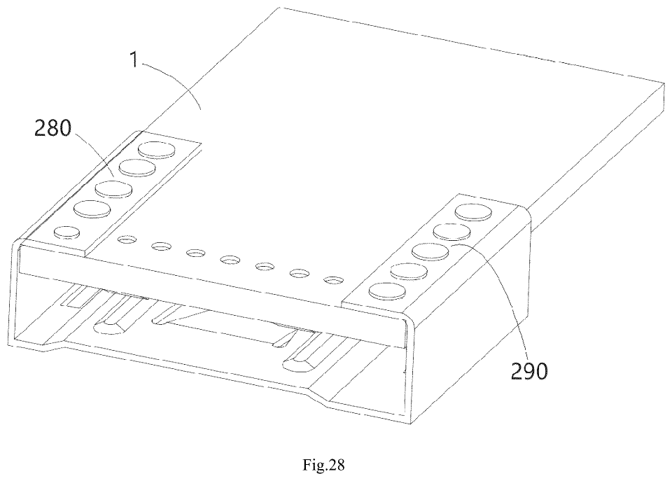

FIG. 27 shows an illustrative perspective view of a terminal according to the fourteenth embodiment of the present invention when viewed from the top. FIG. 28 shows an illustrative perspective view of the terminal according to the fourteenth embodiment of the present invention when viewed from the bottom. A difference between the fourteenth embodiment shown in FIGS. 27 and 28 and the eighth embodiment shown in FIGS. 17 and 18 is the different riveting positions of the left riveting plate 280 and the right riveting plate 290.

In the eighth embodiment shown in FIGS. 17 and 18, the left riveting plate 280 and the right riveting plate 290 are riveted to the top surface of the terminal plate 1. In the fourteenth embodiment shown in FIGS. 27 and 28, the left riveting plate 280 and the right riveting plate 290 are riveted to the bottom surface of the terminal plate 1. In addition, in the fourteenth embodiment shown in FIGS. 27 and 28, the protruding ribs 2b on the top plate 20 of the limit shell 2 extend longitudinally along the terminal plate 1, and the elastic locking buckle 2d is located in the middle of the top plate 20 and in an inclined spring like shape.

As shown in FIGS. 1-28, in the illustrated embodiment, the limit shell 2 is an integral stamped part.

As shown in FIGS. 1-28, in another exemplary embodiment of the present invention, a connector is also disclosed. The connector mainly includes a housing (not shown) and the aforementioned terminal. The terminal is inserted into the housing.

As shown in FIGS. 1-28, in another exemplary embodiment of the present invention, a connector assembly is also disclosed. The connector component includes a connector and a mating connector. The mating connectors is mated with the connector. The mating connector includes a mating housing and a mating terminal provided in the mating housing. The mating housing is used to mate with the housing of the connector. The mating terminal is used to be inserted between the elastic contact member 3 of the connector and the top plate 20 of the limit shell 2, in order to make electrical contact with the elastic contact member 3 of the connector.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

1. A terminal, comprising:
a single terminal plate with top and bottom surfaces opposite to each other in a thickness direction;
a limit shell, including:
a top plate located above the top surface of the terminal plate; and
side plates connected to the top plate and fixed to the terminal plate by riveting; and
an elastic contact member arranged on the top surface of the terminal plate and facing the top plate of the limit shell, the elastic contact member adapted to make electrical contact with a mating terminal inserted between the elastic contact member and the top plate of the limit shell and enabling electrical connection between the terminal and the mating terminal.

2. The terminal according to claim 1, wherein:
the terminal plate has a front end and a rear end that are opposite to each other in a longitudinal direction, and the limit shell and the elastic contact member are installed on the front portion of the terminal plate; and
the limit shell has left and right openings opposite to each other in a transverse direction of the terminal plate to allow the mating terminal to be inserted between the elastic contact member and the top plate of the limit shell along the transverse direction of the terminal plate.

3. The terminal according to claim 2, wherein:
the side plates of the limit shell include:
a front side plate connected to the front side of the top plate; and
a rear side plate connected to the rear side of the top plate;
the limit shell further comprises:
a front riveting plate connected to the lower side of the front side plate and bent vertically towards the rear; and
a rear riveting plate connected to the lower side of the rear side plate and bent vertically towards the rear; and
the front riveting plate is riveted to the top or bottom surface of the terminal plate, and the rear riveting plate is riveted to the top surface of the terminal plate to fix the limit shell to the terminal plate.

4. The terminal according to claim 3, wherein the front riveting plate comprises a pair of strip like portions riveted to the terminal plate, which are respectively located on the left and right sides of the terminal plate and extend along the longitudinal direction of the terminal plate.

5. The terminal according to claim 3, wherein multiple riveting holes are respectively formed in the front riveting plate and the rear riveting plate, and multiple riveting posts are formed on the terminal plate, the multiple riveting posts are respectively riveted into the multiple riveting holes to rivet the front riveting plate and the rear riveting plate to the terminal plate.

6. The terminal according to claim 5, wherein:
the front riveting plate is riveted to the top surface of the terminal plate, and the riveting post protrudes from the top surface of the terminal plate; and
multiple operating holes corresponding to the multiple riveting holes in the front riveting plate are formed in the top plate of the limit shell to allow riveting stamping heads on a riveting tool to pass through the top plate.

7. The terminal according to claim 2, wherein:
the side plates of the limit shell include:
a front side plate connected to the front side of the top plate; and
a rear side plate connected to the rear side of the top plate;
the limit shell further comprises:
multiple riveting pieces connected to the lower side of the front side plate and extending downwards; and
a rear riveting plate connected to the lower side of the rear side plate and bent vertically towards the rear; and
multiple riveting grooves corresponding to the multiple riveting pieces are formed on the front end surface of the terminal plate, and the multiple riveting grooves are arranged in a row along the transverse direction of the terminal plate,
the multiple riveting pieces are respectively riveted into the multiple riveting grooves, and the rear riveting plate is riveted to the top surface of the terminal plate to fix the limit shell to the terminal plate.

8. The terminal according to claim 2, wherein:
the side plates of the limit shell include:
a front side plate connected to the front side of the top plate; and
a rear side plate connected to the rear side of the top plate;
the limit shell further comprises:
at least one pair of rivet legs connected to the lower side of the front side plate and extending downwards; and
a rear riveting plate connected to the lower side of the rear side plate and bent vertically towards the rear; and
at least one slot corresponding to at least one pair of rivet legs is formed on the terminal plate, and each pair of rivet legs passes through a corresponding slot and is riveted to the bottom surface of the terminal plate, the rear riveting plate is riveted to the top surface of the terminal plate to fix the limit shell to the terminal plate.

9. The terminal according to claim 5, wherein:
the limit shell further comprises a pair of positioning parts connected to the lower side of the front side plate and bent vertically towards the rear; and
a pair of positioning slots are formed on the top surface of the terminal plate, and the pair of positioning slots are respectively located on the left and right sides of the terminal plate, the pair of positioning parts are positioned in the pair of positioning slots.

10. The terminal according to claim 9, wherein:
a positioning groove is formed on the lower side of the front side plate of the limit shell, and the positioning groove is located between the pair of positioning parts; and
the terminal plate has a positioning protrusion located between the pair of positioning slots, and the positioning protrusion is positioned in the positioning groove.

11. The terminal according to claim 1, wherein:
the terminal plate has a front end and a rear end that are opposite to each other in its longitudinal direction, and the limit shell and the elastic contact member are installed on the front portion of the terminal plate; and
the limit shell has front and rear openings opposite to each other in the longitudinal direction of the terminal plate, to allow the mating terminal to be inserted from the front opening of the limit shell along the longitudinal direction of the terminal plate.

12. The terminal according to claim 11, wherein:
the side plates of the limit shell include:
a left side plate connected to the left side of the top plate; and
a right side plate connected to the right side of the top plate;
the limit shell further comprises:
a left riveting plate connected to the lower side of the left side plate and bent vertically to the right; and
a right riveting plate connected to the lower side of the right side plate and bent vertically to the left; and
the left riveting plate and the right riveting plate are riveted to the top or bottom surface of the terminal plate to fix the limit shell to the terminal plate.

13. The terminal according to claim 12, wherein multiple riveting holes are respectively formed in the left riveting plate and the right riveting plate, and multiple riveting posts are formed on the terminal plate, the multiple riveting posts are respectively riveted into the multiple riveting holes to rivet the left riveting plate and the right riveting plate to the terminal plate.

14. The terminal according to claim 13, wherein:
the left riveting plate and the right riveting plate are riveted to the top surface of the terminal plate, and the riveting post protrudes from the top surface of the terminal plate; and
multiple operating holes respectively corresponding to the riveting holes in the left riveting plate and the right riveting plate are formed in the top plate of the limit shell enabling riveting stamping heads on a riveting tool to pass through the top plate.

15. The terminal according to claim 2, wherein at least one inwardly protruding rib is formed on the top plate of the limit shell and extends along the longitudinal direction or transverse direction of the terminal plate to apply a predetermined pressure on the inserted mating terminal.

16. The terminal according to claim 2, wherein a foolproof protrusion is formed on the top plate of the limit shell, and is adapted to cooperate with a guide groove in the housing of the connector to guide the terminal to be inserted into the housing of the connector in the correct orientation.

17. The terminal according to claim 2, wherein one or more elastic locking buckles are formed on the top plate of the limit shell, and are adapted to engage with the housing of the connector to lock the terminals in the housing of the connector.

18. The terminal according to claim 12, wherein an elastic locking buckle is formed on the left side plate and/or right side plate of the limit shell, and is adapted to engage with the housing of the connector to lock the terminal in the housing of the connector.

19. The terminal according to claim 1, wherein the limit shell is an integral stamped part.

20. A connector, comprising:
a housing; and
a terminal inserted into the housing, comprising:
a single terminal plate with top and bottom surfaces opposite to each other in a thickness direction;
a limit shell, including:
a top plate arranged above the top surface of the terminal plate; and
side plates connected to the top plate and fixed to the terminal plate by riveting; and
an elastic contact member installed on the top surface of the terminal plate and facing the top plate of the limit shell, the elastic contact member is adapted to make electrical contact with a mating terminal inserted between the elastic contact member and the top plate of the limit shell, in order to achieve electrical connection between the terminal and the mating terminal.
